(19) United States
(12) Patent Application Publication
(10) Pub. No.: US 2016/0205443 A1
(43) Pub. Date: Jul. 14, 2016

(54) SYSTEM AND METHOD FOR REAL-TIME ADVERTISMENTS IN A BROADCAST CONTENT

(71) Applicant: ADSPARX USA INC, Dover, DE (US)

(72) Inventors: Lilesh Sharad Ghadi, Mumbai (IN); Ketan Avinash Barhate, Thane (IN); Kunal Janardan Lagwankar, Thane (IN)

(21) Appl. No.: 14/595,384

(22) Filed: Jan. 13, 2015

(51) Int. Cl. H04N 21/81; H04N 21/235; H04N 21/2668; H04N 21/435

(52) U.S. Cl. CPC H04N 21/812; H04N 21/435; H04N 21/235; H04N 21/2668

(57) ABSTRACT

A content streaming system includes a streaming server and a cue-point engine is provided. The streaming server receives a request from a user for a multimedia content, obtains a broadcast content including the multimedia content and static advertisements, and obtains a device parameter, a network parameter, and/or user information. The cue-point engine obtains pre-defined start time and pre-defined end time of pre-defined advertisement slots of the broadcast content from a data source. The cue-point engine further analyses audio signatures or encoding parameters of data packets of the broadcast content and identifies actual start time and actual end time of each of the pre-defined advertisement slots. The streaming server further receives real-time advertisements, replaces a plurality of static advertisements occur in between an actual start time and an actual end time of an advertisement slot with the real-time advertisements, and streams broadcast content to a user device.

### BACKGROUND

1. Technical Field

The embodiments herein generally relate to a system and method for streaming broadcast content, and, more particularly, to a system and method for identifying a right point in a broadcast content for stitching real-time advertisements that are customized to one or more content requesters, and airing the broadcast content.

2. Description of the Related Art

Advertising on user devices such as televisions, internet connected devices, computers, desktops, laptops, smartphones, etc., while streaming a broadcast content being watched by various users is an effective way for reaching out massive audience. Typically, advertisements are stitched with a program at pre-defined slots well before the program starts (i.e., not in a real-time). These advertisements are then streamed at user devices at the pre-defined slots. Also, these advertisements are not targeted to an individual or a group of users. In other words, the same advertisements are streamed at all user devices.

The existing approaches address the above problem by stitching target advertisements with a program in a real-time. However, this is achieved using client side software development kit (SDK). The client side component hits first an advertisement server, fetches advertisement and then again hits a content server and gets the streaming content. This two-step process creates a discontinuity in the user experience since there is a distinct buffering delay approximately from 1 to 10 seconds depending upon availability of bandwidth on user side, a bitrate of streaming content and initial buffering requirements of client. Further such approaches require that a publisher of an application integrate advertiser SDK with publisher's application. This is not always possible since an operating system used by a user side device may not support development of SDKs (for e.g., custom manufactured set top box, connected televisions), may take several months to develop and integrate the client side SDK thereby delaying launch to market plans for a content owner. Furthermore in case of midrolls, when an advertisement slot starts, there is a buffering before an advertisement starts and between every separate advertisement within the advertisement slot, since for every advertisement the advertisement server is hit and the advertisement is fetched for streaming.

In addition, existing approaches where static advertisements are stitched in to content stream need integration in encoders that encode content data packets to work with a media streaming server and a content delivery network. This makes the system complex and costly too. Accordingly, there remains a need for a system and a method for stitching targeted advertisements without disrupting user experience, at a right point in a broadcast content in real-time.

### SUMMARY

In view of the foregoing, an embodiment herein provides a content streaming system. The content streaming system includes a streaming server and a cue-point engine. The streaming server includes (i) a memory unit that includes a database and a set of modules, and (ii) a processor that executes the set of modules. The set of modules include a request receiving module, a broadcast content obtaining module, and a parameter obtaining module. The request receiving module receives a request from a user for a multimedia content. The broadcast content obtaining module obtains a broadcast content including the multimedia content and static advertisements from a content repository based on the request. The static advertisements (a) are being stitched with the multimedia program at pre-defined advertisement slots and (b) are common to a plurality of users who request the broadcast content. The parameter obtaining module obtains a device parameter that is related to a user device, a network parameter that is related to a network that interconnects the user device and the streaming server, and user information.

The cue-point engine communicatively coupled to the streaming server. The cue-point engine includes (i) a memory unit including (i) a set of modules and (ii) a database, and (ii) a processor that executes the set of modules. The set of modules include a timestamp obtaining module and a clock drift identification module. The timestamp obtaining module obtains pre-defined start time and pre-defined end time of the pre-defined advertisement slots of the broadcast content from a data source (e.g., fixed point chart or SCTE35). The clock drift identification module analyses audio signatures or encoding parameters of data packets associated with the broadcast content. The clock drift identification module further identifies (a) the pre-defined advertisement slots of the broadcast content, and (b) actual start time and actual end time of each of the pre-defined advertisement slots based on analysis of the audio signatures or the encoding parameters. A mismatch between (a) a predefined start time of an advertisement slot of the predefined advertisements slots and an actual start time of the advertisement slot, or (b) a predefined end time of an advertisement slot of the predefined advertisements slots and an actual end time of the advertisement slot is identified.

The streaming server is further configured to (a) receive real-time advertisements based on at least one of the device parameter, the network parameter and/or the user information, (b) replace a plurality of static advertisements occur in between the actual start time and the actual end time of the advertisement slot with the real-time advertisements upon identifying the mismatch, and (c) stream the multimedia content along with the real-time advertisements to the user device. The real-time advertisements start to stream at the actual start time.

The streaming server may further configure to obtain user information including location information of a plurality of users requesting the broadcast content. A first set of advertisements targeting a first group of users of the plurality of users having at least one common targeting parameters may be obtained. Static advertisements at the pre-defined advertisement slots of the broadcast content may be replaced with the first set of advertisements. The static advertisements at the pre-defined advertisement slots are mid-roll advertisements. A first set of content streams including the broadcast content may be communicated to user devices of the first group of users for streaming the broadcast content. The broadcast content includes the multimedia content that may be stitched with the first set of advertisements.

The streaming server may be further configured to obtain a second set of advertisements targeting a second group of users of the plurality of users having at least one common targeting parameters. Static advertisements at the pre-defined advertisement slots of the broadcast content may be replaced with the second set of advertisements. The static advertisements at the pre-defined advertisement slots are mid-roll advertisements. A second set of content streams including the broadcast content may be communicated to user devices of the second group of users. The broadcast content includes the multimedia content that may be stitched with the second set of advertisements. The streaming server may receive a new request from another user for the broadcast content. User information including location information of the user may be obtained. A match group may be identified based on targeting parameters and the user information. The match group is the first group of users or the second group of users having at least one common targeting parameters with respect to the user information. A stream from the first set of streams or the second set of streams based on the match group may be re-used to communicate the broadcast content to a user device associated with the user. The first group of users and second group of users may be dynamically updated based on a new campaign, a change in the targeting parameters associated with the first group or the second group, or an expiry of existing campaign.

The content streaming system may further include an advertisement server that is communicatively coupled to the streaming sever and the cue-point engine. The advertisement server may be configured to (a) select the real-time advertisements dynamically based on at least one of the device parameter, the network parameter or the user information, (ii) provide an interface for content publishers to ingest broadcast content and properties of the broadcast content, and (iii) provide an interface for advertisers to provide campaign data.

The content streaming system may further include an advertisement stitching engine. The advertisement stitching engine includes a content format parsing module, an advertisement format processing module, and a content stitching module. The content format parsing module (i) may parse data packets of the multimedia content to extract the encoding parameters, (ii) interacts with the cue-point engine to obtain the pre-defined advertisement slots that is identified based on the audio signatures or the encoding parameters, and (iii) interacts with the advertisement server to obtain the real-time advertisements dynamically. The advertisement format processing module may repurpose the real-time advertisements to match with the encoding parameters of the multimedia content. The advertisement inserting module may insert the real-time advertisements in between the multimedia content for streaming at the user device.

The encoding parameters may be selected from the group comprising of: resolution, frame rate, reference frames, codec and profile, initial quantization parameters, deblocking filter coefficients, sequence parameter set, picture parameter set, audio codec and profile, sampling rate, and number of channels. The real-time advertisements may be at least one of a pre-roll advertisement and a mid-roll advertisement. The clock drift identification module may further (a) identify a presence of silence in the broadcast content before starting of each of the pre-defined advertisement slot, and (b) identify an actual start time of each of the pre-defined advertisement slots based on the presence of silence that is identified. The clock drift identification module may further identify the actual start time of each of the pre-defined advertisement slots based on a presence of a black frame in the broadcast content before starting of each of the pre-defined advertisement slots.

The streaming server (a) streams at least one pre-roll advertisement before streaming the multimedia content that is requested by a plurality of users, and (b) streams the multimedia content or the real-time advertisements based on available data packets after completing streaming of the pre-roll advertisement. The advertisement server or the advertisement stitching engine further includes a timestamp modifying module that modifies timestamp associated with packets of the real-time advertisements by adding the timestamp of packets of the real-time advertisements with a timestamp at a start packet of the multimedia content.

In another aspect, a method for inserting real-time advertisements in a broadcast content and streaming the broadcast content is provided. The method includes receiving a request from a user for a multimedia content. A broadcast content including the multimedia content and static advertisements is obtained from a content repository based on the request. The static advertisements are being stitched with the multimedia content at pre-defined advertisement slots. At least one of a device parameter that is related to a user device, a network parameter that is related to a network that interconnects the user device and a streaming server, and/or user information is obtained. Pre-defined start time and pre-defined end time of pre-defined advertisement slots of the broadcast content is obtained from a data source. Audio signatures or encoding parameters of data packets associated with the broadcast content is analyzed. The pre-defined advertisement slots of the broadcast content, and (b) actual start time and actual end time of each of the pre-defined advertisement slots is identified based on analysis of the audio signatures or the encoding parameters.

Real-time advertisements are obtained based on at least one of the device parameter, the network parameter and/or the user information. A plurality of static advertisements occur in between an actual start time and an actual end time of an advertisement slot of the pre-defined advertisement slots is replaced with the real-time advertisements. The real-time advertisements start to stream at the actual start time. The multimedia content along with the real-time advertisements is streamed to the user device.

User information including location information of a plurality of users requesting the broadcast content may be obtained. A first set of advertisements targeting a first group of users of the plurality of users having at least one common targeting parameters may be obtained. The static advertisements at the pre-defined advertisement slots of the broadcast content may be replaced with the first set of advertisements. The static advertisements at the pre-defined advertisement slots may be mid-roll advertisements. A first set of content streams including the broadcast content may be communicated to user devices of the first group of users for streaming the broadcast content. The broadcast content may include the multimedia content that is stitched with the first set of advertisements.

A second set of advertisements targeting a second group of users of the plurality of users having at least one common targeting parameters may be obtained. The static advertisements at the pre-defined advertisement slots of the broadcast content may be replaced with the second set of advertisements. The static advertisements at the pre-defined advertisement slots may be mid-roll advertisements. A second set of content streams including the broadcast content may be communicated to user devices of the second group of users. The broadcast may include the multimedia content that is stitched with the second set of advertisements. A new request may be received from another user for the broadcast content. User information including location information of the user is obtained. A match group may be identified based on targeting parameters and the user information. The match group may be the first group of users or the second group of users having at least one common targeting parameters with respect to the user information. A stream from the first set of streams or the second set of streams may be re-used based on the match group to communicate the broadcast content to a user device associated with the user.

In yet another aspect, a cue-point engine is provided. The cue-point engine includes (i) a memory unit including (a) a set of modules and (b) a database, and (ii) a processor that executes the set of modules. The set of modules include a timestamp obtaining module and a clock drift identification module. The timestamp obtaining module, executed by the processor, that obtains pre-defined start time and pre-defined end time of pre-defined advertisement slots of a broadcast content from a data source. The broadcast content includes the multimedia content and static advertisements are obtained from a content repository.

The clock drift identification module analyses audio signatures or encoding parameters of data packets associated with the broadcast content, and identifies (a) the pre-defined advertisement slots of the broadcast content, and (b) actual start time and actual end time of each of the pre-defined advertisement slots based on analysis of the audio signatures or the encoding parameters. The clock drift identification module further identifies a mismatch between (a) a predefined start time of an advertisement slot of the predefined advertisements slots and an actual start time of the advertisement slot, or (b) a predefined end time of an advertisement slot of the predefined advertisements slots and an actual end time of the advertisement slot. A plurality of static advertisements occurs in between the actual start time and the actual end time of the advertisement slot is replaced with real-time advertisements upon identifying the mismatch. The multimedia content along with the real-time advertisements is streamed to a user device.

The cue-point engine is further coupled to an advertisement server. The advertisement server may be configured to (a) select the real-time advertisements dynamically based on at least one of the device parameter, the network parameter or the user information, (ii) provide an interface for content publishers to ingest broadcast content and properties of the broadcast content, and (iii) provide an interface for advertisers to provide campaign data. The encoding parameters may be selected from the group comprising of: resolution, frame rate, reference frames, codec and profile, initial quantization parameters, deblocking filter coefficients, sequence parameter set, picture parameter set, audio codec and profile, sampling rate, and number of channels. The real-time advertisements are mid-roll advertisements.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a system view illustrating a content streaming system including a user requesting a streaming server for a multimedia content using a user device according to one embodiment of the present disclosure.

FIG. 2 is an exploded view of the streaming server of FIG. 1 according to one embodiment of the present disclosure.

FIG. 3 is an exploded view of the cue-point engine of FIG. 1 according to one embodiment of the present disclosure.

FIG. 4 is an exploded view of an advertisement stitching engine of FIG. 1 according to one embodiment of the present disclosure.

FIG. 5 is a table view illustrating an example of a fixed point chart that includes a broadcast content data including program details, start time, and end time of various programs according to one embodiment of the present disclosure.

FIG. 6 is a graphical representation depicting a schedule of a broadcast content that is obtained from the fixed point chart in accordance according to one embodiment of the present disclosure.

FIG. 7 is a graphical representation depicting a change in a schedule of a broadcast content that is obtained from the fixed point chart due to clock drift according to one embodiment of the present disclosure.

FIG. 8 is a graphical representation depicting a broadcast content including real-time advertisements that are stitched instead of static advertisements according to one embodiment of the present disclosure.

FIG. 9 is a table view illustrating groups of users requesting a broadcast content who are categorized based on target parameters set by an advertiser, and advertisements targeting each group of users according to one embodiment of the present disclosure.

FIG. 10 is a flow diagram illustrating a method for reusing a stream to deliver or communicate a broadcast content to a user device of a new user according to one embodiment of the present disclosure.

FIG. 11 is a flow diagram illustrating a method for streaming a multimedia content stitched with real-time advertisements to a user device of a user according to one embodiment of the present disclosure.

FIG. 12 illustrates an exploded view of a receiver used in accordance with the embodiments herein; and

FIG. 13 illustrates a schematic diagram of a computer architecture used in accordance with the embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

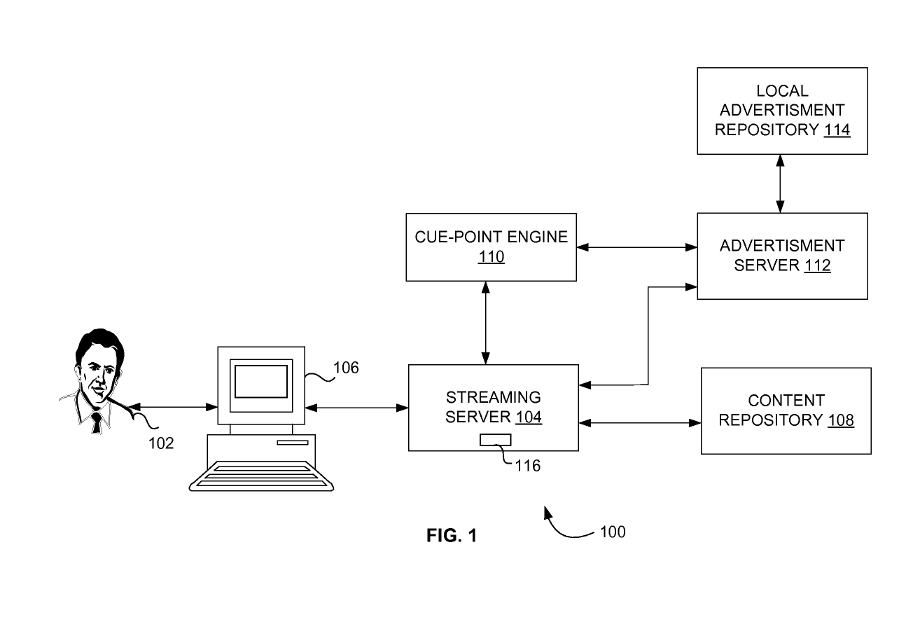

As mentioned, there remains a need for a system and a method for stitching targeted advertisements at a right point in a broadcast content in real-time and effectively utilizing streams and hence avoid the system becomes instable, and also helping publisher to maximize the fill rate (e.g., money obtained from advertising on content) and providing a seamless experience to the viewer. The embodiments herein achieve this by providing a cue-point engine that identifies advertisements slots in a broadcast content, and a streaming server that replaces static advertisements at the advertisement slots with one or more real time advertisements. Referring now to the drawings, and more particularly to FIGS. 1 through 13, where similar reference characters denote corresponding features consistently throughout the figures, there are shown preferred embodiments.

The ‘broadcast content’ which is described throughout various embodiments herein is a multimedia content that includes a video and/or audio program content stitched with one or more static advertisements at pre-defined advertisement slots. The ‘static advertisement’ which is described throughout various embodiments herein is an advertisement content which is common to a plurality of users who request a broadcast content. The ‘real-time advertisement’ which is described throughout various embodiments herein is an advertisement content obtained from a local advertisement repository dynamically. The ‘cue-point’ which is described throughout various embodiments herein is a time marker that represents an event within a video. The event is occurrence of program content and/or advertisement content. The ‘pre-defined advertisement slots’ which is described throughout various embodiments herein indicates places in the broadcast content that are already defined for stitching advertisements. The ‘pre-defined start time’ which is described throughout various embodiments herein is a time at which each of the pre-defined advertisement slots of the broadcast content is scheduled to start. The ‘pre-defined end time’ which is described throughout various embodiments herein is a time at which each of the pre-defined advertisement slots of the broadcast content is scheduled to end. The ‘actual start time’ which is described throughout various embodiments herein is a time at which the pre-defined advertisement slot(s) of the broadcast content actually starts due to a clock drift in a content streaming system. The ‘actual end time’ which is described throughout various embodiments herein is a time at which the pre-defined advertisement slot(s) of the broadcast content actually ends due to a clock drift in a content streaming system. The ‘clock drift’ which is described throughout various embodiments herein is a time difference between a streaming server clock and timestamps of a broadcast content from a data source.

FIG. 1 is a system view illustrating a content streaming system 100 including a user 102 requesting a streaming server 104 for a multimedia content using a user device 106 according to one embodiment of the present disclosure. The content streaming system 100 further includes a content repository 108, a cue-point engine 110, an advertisement server 112, and a local advertisement repository 114. The streaming server 104 further includes an advertisement stitching engine 116. In one embodiment, the advertisement stitching engine 116 is implemented in hardware of the streaming server 104. The streaming server 104 receives a request from the user 102 for a multimedia content, and processes the request to obtain a broadcast content that includes the multimedia content from the content repository 108. The content repository 108 stores a plurality of broadcast content. Each broadcast content includes a multimedia content stitched with a plurality of static advertisements at pre-defined advertisement slots. In one embodiment, the content repository 108 stores a plurality of broadcast content associated with a plurality of TV channels. In one embodiment, the content repository 108 stores a plurality of broadcast content that are on-demand multimedia content.

The cue-point engine 110 obtains pre-defined start time and pre-defined end time of pre-defined advertisement slots in a broadcast content that is requested by the user 102 from a data source. In one embodiment, the data source is a fixed point chart that includes broadcasting schedule of programs for a specific duration (e.g., for a week). In one embodiment, the data source is a SCTE-35. The cue-point engine 110 further identifies a clock drift (e.g., a delay) in airing a broadcast content that is requested by the user 102, and identifies an actual start time and actual end time of each of the pre-defined advertisement slots.

The local advertisement repository 114 caches a plurality of real-time advertisements. The advertisement server 112 includes a set of rules which implement the business logic for selection of real-time advertisements from the publisher defined campaigns or the campaigns available from the third party advertisement exchange. The advertisement server 112 provides user interfaces which allows a publisher to define all the streaming content (e.g., advertisements, program content, etc) with its properties which include a content name, a genre, stream names for each profile, profile details (e.g., includes video and audio properties of the stream), an ingest URL, a public URL, application/domain names, advertisement status (e.g., enable or disable), advertisement frequency, allowed regions and other meta data of the channel.

The advertisement server 112 further allows an advertiser to configure campaign details which include a campaign schedule, target impressions, budget, vast tags, daily/weekly limits, targeting parameters like targeted regions, content genres, timeslots, platforms, devices, user demographics like age and sex, advertisement type (e.g., pre-roll or mid-roll), content type (e.g., live or video on demand), etc. Based on a user provided information (i.e., publisher ingested content and advertiser configured data), and parameters that are related to the user device 106, a network that interconnects the user device 106 and the streaming server 104, and/or user information, the advertisement server 112 selects a set of customized real-time advertisements from the local advertisement repository 114. The advertisement stitching engine 116 replaces one or more static advertisements that occur in between an actual start time and an actual end time of a pre-defined advertisement slot with the set of customized real-time advertisements.

In one embodiment, the static advertisement and/or real-time advertisements are pre-roll advertisements, mid-roll advertisements, and/or post-roll advertisements. The pre-roll advertisements are promotional message that stream before a multimedia content that the user 102 has requested starts playing. The mid-roll advertisements are promotional message that stream in between a multimedia content that the user 102 has requested. The post-roll advertisements are promotional message that occurs after a requested multimedia content is completed.

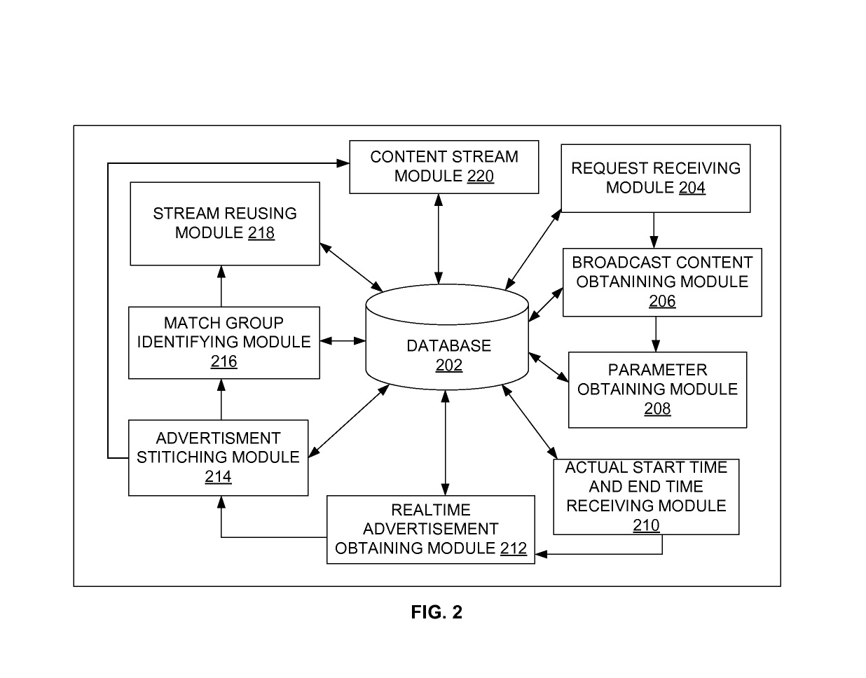

FIG. 2 is an exploded view of the streaming server 104 of FIG. 1 according to one embodiment of the present disclosure. The streaming server 104 includes a database 202, a request receiving module 204, a broadcast content obtaining module 206, a parameter obtaining module 208, an actual start time and end time receiving module 210, real time advertisement obtaining module 212, an advertisement stitching module 214, a match group identifying module 216, a stream reusing module 218, and a content stream module 220. The request receiving module 204 receives a request from the user 102 for a multimedia content. In one embodiment, the request receiving module 204 is in the form of a plugin of the streaming server 104. Popular streaming servers like Adobe streaming server, Wowza, Apache, Darwin support extending their functionalities by making a provision of introducing custom plugins in their architecture.

The broadcast content obtaining module 206 that obtains a broadcast content including the multimedia content and static advertisements from the content repository 108 based on the request. The static advertisements are being stitched with the multimedia program at pre-defined advertisement slots and (b) are common to a plurality of users who request the broadcast content.

The parameter obtaining module 208 that obtains a device parameter that is related to the user device 106, a network parameter that is related to a network that interconnects the user device 106 and the streaming server 104, and user information. The device parameter includes, but not limited to, a unique identification number, a user agent, etc. The network parameter includes, but not limited to, an IP address. The user information may include gender, age, license type, viewing history, interests, etc. The actual start time and end time receiving module 210 receives actual start time and actual end time of pre-defined advertisements slots of a broadcast content from the cue-point engine 110 for stitching one or more real-time advertisements at the pre-defined advertisements slots. The real-time advertisement obtaining module 212 obtains one or more real-time advertisements that are customized to one or more users based on a device parameter, a network parameter, and/or user information from the local advertisement repository 114. The advertisement stitching module 214 replaces static advertisements at the pre-defined advertisement slots with the one or more real-time advertisements between the actual start point and the actual end point.

In one embodiment, the streaming server 104 (a) streams at least one pre-roll advertisement before streaming a multimedia content that is requested by a plurality of users. and (b) streams the multimedia content or the real-time advertisements based on available data packets after completing streaming of the pre-roll advertisement. When the user 102 connects with the content streaming system 100, one or more pre-roll advertisements may be streamed first before streaming a requested multimedia content.

The streaming server 104 further receives a plurality of requests for a multimedia content from a plurality of users, and obtains user information including location information of the plurality of users. The streaming server 104 groups the plurality of users into two or more groups (e.g., a first group of users and a second group of users) based on the user information and/or targeting parameters that are already set by an advertiser.

In one embodiment, a group of users in a set have at least one common target parameters. The real-time advertisement obtaining module 212 queries the advertisement server 112 to check which campaign is available that matches targeting parameters of the first group of users, and replace static advertisements at pre-defined advertisement slots of a broadcast content that includes the multimedia content with the first set of advertisements. The streaming server 104 further communicates a first set of content streams including the broadcast content to user devices of the first group of users for streaming the broadcast content.

Similarly, the real-time advertisement obtaining module obtains a second set of advertisements targeting the second group of users from the local advertisement repository 114, and replace static advertisements at a pre-defined advertisement slots of a broadcast content that includes the multimedia content with the second set of advertisements. The streaming server 104 further communicates a second set of content streams including the broadcast content to user devices of the second group of users for streaming the broadcast content.

The match group identifying module 216 receives a new request from a user for a multimedia content which is already being viewed by a plurality of users. The match group identifying module 216 then obtains a user information including a location information of the user, and identifies a match group (e.g., the first group or the second group) based on targeting parameters and the user information. In one embodiment, identification of a match group includes comparing information of the user with targeting parameters of first group of users and second group of users, and identifying a best match. The stream reusing module re-uses a stream through which the broadcast content has been aired to one of a plurality of existing viewers who is not watching the broadcast content now to communicate the broadcast content to a user device associated with the user. The content stream module streams the broadcast content to a plurality of user devices associated with a plurality of users. In one embodiment, the first group of users and/or the second group of users are dynamically updated based on a new campaign, a change in the targeting parameters associated with the first group or the second group, or termination or an expiry of existing campaign. For example, an existing campaign (e.g., streaming an advertisement related to a product ‘A’) targets the first group of users who are all located in the United States. Based on a new campaign (e.g., streaming an advertisement related to a product ‘B’ for the multimedia content requests from California), the first group of users may be filtered to identify users from California, and advertisement related to the product ‘B’ may be streamed only at the devices of users from California.

The advertisement server 112 or the advertisement stitching engine 116 further includes a timestamp modifying module (not shown in the FIGS) that modifies timestamp associated with real-time advertisements by adding the timestamp of the real-time advertisements with a timestamp at a start packet of the multimedia content. For example, time stamp associated with content packets are 10000, 10030, 10059, 10090, and 10120. A timestamp 10000 from which advertisement starts. When the timestamp modifying module reads an advertisement file, advertisements in the advertisement file are packetized and include timestamps (e.g., 0, 30, 60, 90, 120, and 150). The timestamp modifying module modifies timestamp of the advertisements based on the timestamp at a start packet of the multimedia content (i.e., 10000+0, 10000+30, 10000+60, 10000+90 . . . ). The timestamp modifying module ensures the timestamps of the advertisement packets are in flow with the content packets.

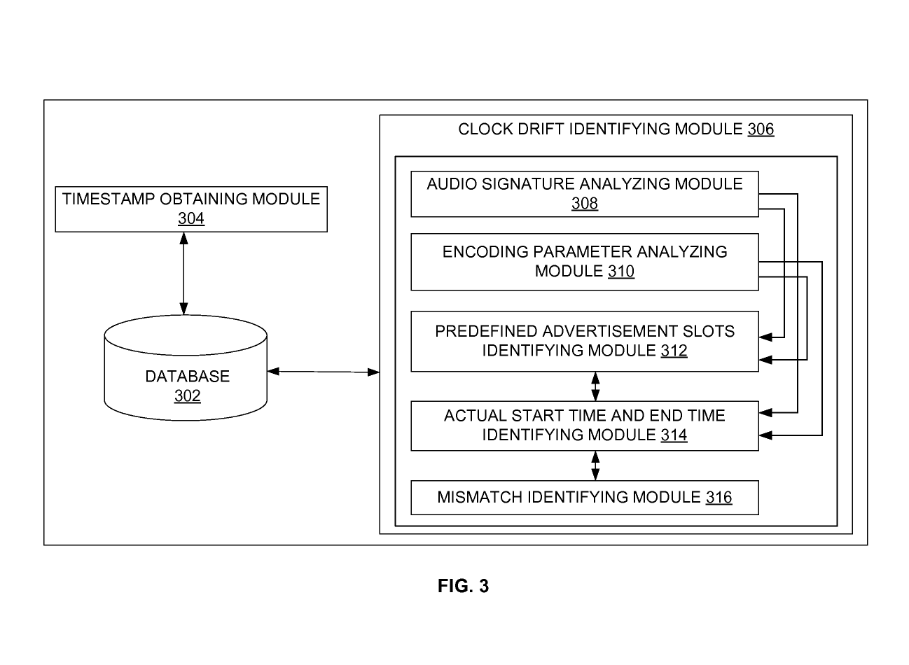

FIG. 3 is an exploded view of the cue-point engine 110 of FIG. 1 according to one embodiment of the present disclosure. The cue-point engine 110 includes a database 302, a timestamp obtaining module 304 and a clock drift identification module 306. The clock drift identification module 306 includes an audio signature analyzing module 308, an encoding parameter analyzing module 310, a predefined advertisement slots identifying module 312, an actual start time and end time identifying module 314, and a mismatch identifying module 316. The timestamp obtaining module 304 obtains pre-defined start time and pre-defined end time of pre-defined advertisement slots of a broadcast content including a multimedia content that is requested by a user from a data source (e.g., a fixed point chart).

The audio signature analyzing module 308 analyses audio signatures of data packets associated with the broadcast content. Audio signatures associated with the multimedia content (e.g., program content) differ from audio signatures of static advertisements at one or more pre-defined advertisement slots. In one embodiment, with the pre-defined start time and the pre-defined end time of the pre-defined advertisement slots from the data source, the audio signature analyzing module 308 compares audio signatures of the multimedia content with audio signatures of data packets at a pre-defined start time of a pre-defined advertisement slot (e.g., a first pre-defined advertisement slot) to check whether static advertisements to be streamed at the first pre-defined advertisement slot starts at a specified time. The audio packets analysis can be performed in frequency domain since audio information gives unique patterns which could be compared and matched. In another embodiment, the audio signature analyzing module 308 analyses data packets of the broadcast content at a regular intervals of time.

The encoding parameter analyzing module 310 analyses encoding parameters of data packets associated with the broadcast content. Encoding parameters associated with the multimedia content differ from encoding parameters of static advertisements at one or more pre-defined advertisement slots when the static advertisements are inserted after encoding the multimedia content. In one embodiment, with the pre-defined start time and the pre-defined end time of the pre-defined advertisement slots from the data source, the encoding parameter analyzing module 310 compares encoding parameter of the multimedia content with encoding parameters of data packets at a pre-defined start time of a pre-defined advertisement slot (e.g., a first pre-defined advertisement slot) to check whether static advertisements to be streamed at the first pre-defined advertisement slot starts at a specified time. The encoding parameters is obtained by going through sequence and picture properties of the video stream include, but not limited to, aspect ratio, default deblocking parameters, initial quantization parameter value, resolution, frame rate, reference frames, codec and profile, initial quantization parameters, deblocking filter coefficients, sequence parameter set, picture parameter set, audio codec and profile, sampling rate, and/or number of channels.

The predefined advertisement slots identifying module 312 identifies a plurality of advertisement slots in the broadcast content by analyzing audio signatures and/or encoding parameters. For example, a broadcast content of 30 minutes which is originally scheduled to start at 5.00 PM, including first 8 minutes of multimedia content (i.e., till 5.08 PM), from 8^{th} minute to 11^{th} (i.e., 5.08 PM to 5.11 PM) minute of a first pre-defined advertisement slot, 11^{th} minute to 19^{th} minute (i.e., 5.11 PM to 5.19 PM) of the multimedia content, from 19^{th} minute to 22^{nd} minute (i.e., 5.19 PM to 5.22 PM) of a second pre-defined advertisement slot, and followed by the multimedia content. By analyzing audio signatures and/or encoding parameters, the predefined advertisement slots identifying module 312 identifies a change in audio signatures and encoding parameters at 8^{th} minute and 22^{nd} minute of broadcast content, and thus identifies starting of the first pre-defined advertisement slot and the second pre-defined advertisement slot. Similarly, change in audio signatures and/or encoding parameters at 11^{th} minute and 22^{nd} minute indicates end of the first pre-defined advertisement slot and the pre-defined second advertisement slot respectively.

The actual start time and end time identifying module 314 identifies timestamps at start time and end time of a plurality of pre-defined advertisement slots in the broadcast content identified by analyzing audio signatures and/or encoding parameters as actual start time and actual end time. For example, when there is clock drift of 1 minute in airing the broadcast content which is originally scheduled to start 5.00 PM, and the broadcast content starts at 5.01 PM due to the clock drift. Accordingly, the first pre-defined advertisement slot is rescheduled to start at 5.09 PM and ends at 5.12 PM, and the second pre-defined advertisement slot is rescheduled to start at 5.20 PM and ends at 5.23 PM. The predefined advertisement slots identifying module 312 identifies a change in audio signatures and/or encoding parameters from 5.09 PM to 5.12 PM and from 5.20 PM to 5.23 PM, and the actual start time and end time identifying module 314 identifies a timestamp (i.e., 5.09 PM) as a start time of the pre-defined first advertisement slot, a timestamp (i.e., 5.12 PM) as an end time of the pre-defined first advertisement slot, a timestamp (i.e., 5.20 PM) as a start time of a pre-defined second advertisement slot, and a timestamp (i.e., 5. 23 PM) as an end time of the pre-defined second advertisement slot.

The mismatch identifying module 316 identifies a mismatch between a predefined start time of an advertisement slot and an actual start time of the advertisement slot, and/or a predefined end time of an advertisement slot and an actual end time of the advertisement slot. From the above example of the broadcast content of 30 minutes which is scheduled to broadcast at 5.00 PM, the predefined start time of the pre-defined first advertisement slot is 5.08 PM. The actual start time of the pre-defined first advertisement slot is 5.09 PM. The mismatch identifying module 316 identifies a mismatch between the predefined start time and the actual start time of the advertisement slot. The streaming server 104 obtains real-time advertisements from the local advertisement repository 114 that are customized to one or more users, and replace a plurality of static advertisements occur in between an actual start time (e.g., 5.09 PM) and an actual end time (5.12 PM) with the one or more real-time advertisements upon identifying the mismatch.

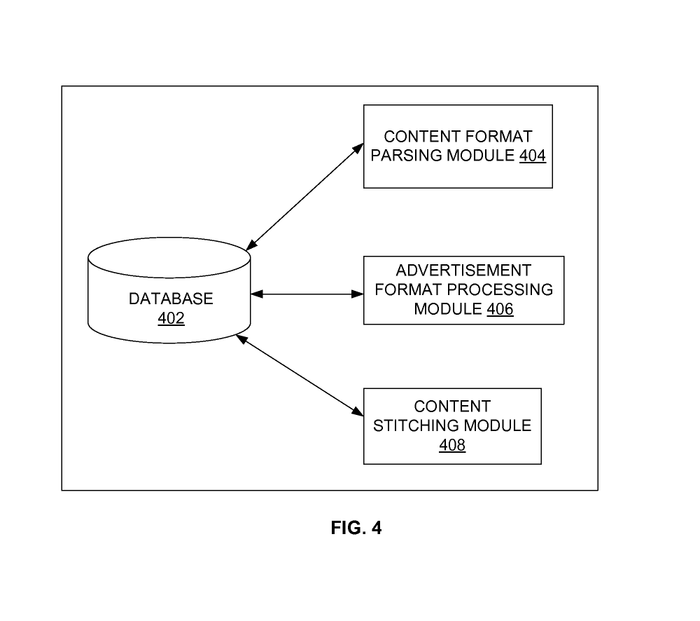

FIG. 4 is an exploded view of an advertisement stitching engine 116 of FIG. 1 according to one embodiment of the present disclosure. The advertisement stitching engine 116 includes a database 402, a content format parsing module 404, an advertisement format processing module 406, and an advertisement inserting module 408. The content format parsing module 404 parses data packets of a multimedia content to extract encoding parameters, interacts with the cue-point engine 110 to obtain the pre-defined advertisement slots that is identified based on the audio signatures or the encoding parameters, and interacts with the advertisement server 112 to obtain the real-time advertisements dynamically. The advertisement format processing module 406 repurposes the real-time advertisements to match with the encoding parameters of the multimedia content. The advertisement inserting module 408 inserts one or more real-time advertisements in between the multimedia content for streaming at one or more user devices.

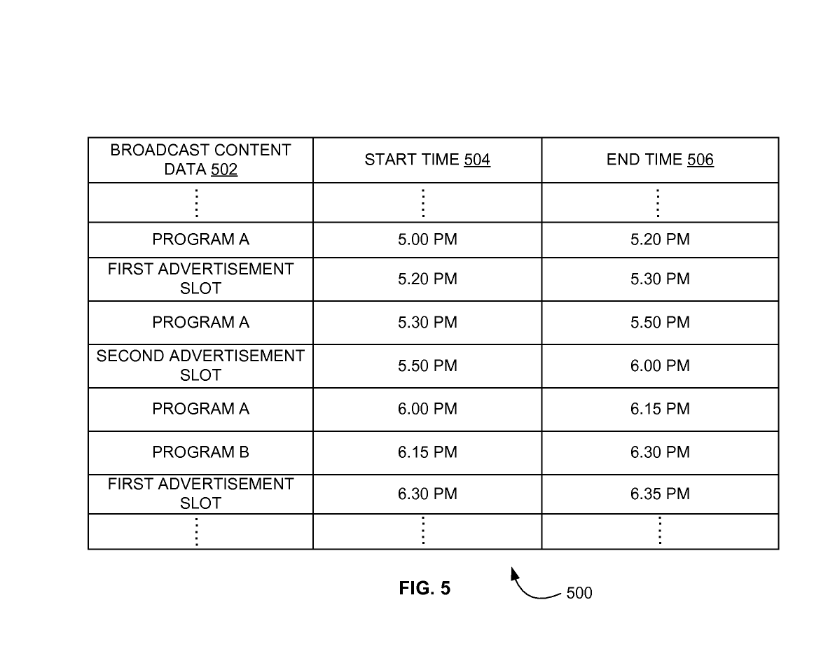

FIG. 5 is a table view illustrating an example of a fixed point chart 500 that includes a broadcast content data 502 including program details, start time 504, and end time 506 of various programs according to one embodiment of the present disclosure.

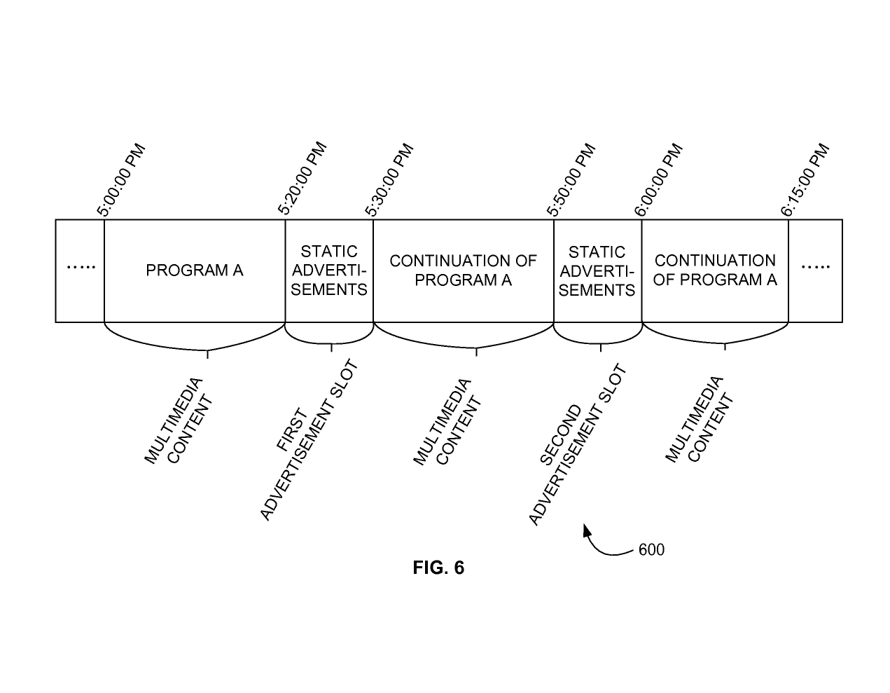

FIG. 6 is a graphical representation 600 depicting a schedule of a broadcast content that is obtained from the fixed point chart 500 in accordance according to one embodiment of the present disclosure. For example, the broadcast content is program A which is scheduled to broadcast from 5.00 PM to 6.15 PM. A first session of the program A is scheduled to start at 5:00:00 PM and end at 5.20:00 PM, followed by a pre-defined first advertisement slot from 5:20:01 PM to 5:30:00 PM, followed by a second session of the program A from 5.30:01 PM to 5:50:00 PM, followed by a pre-defined second advertisement slot from 5:50:01 PM to 6:00:00 PM, and finally followed by a third session of the program A till 6:15:00 PM. The pre-defined first advertisement slot includes a first set of static advertisements, and the pre-defined second advertisement slot includes a second set of static advertisements.

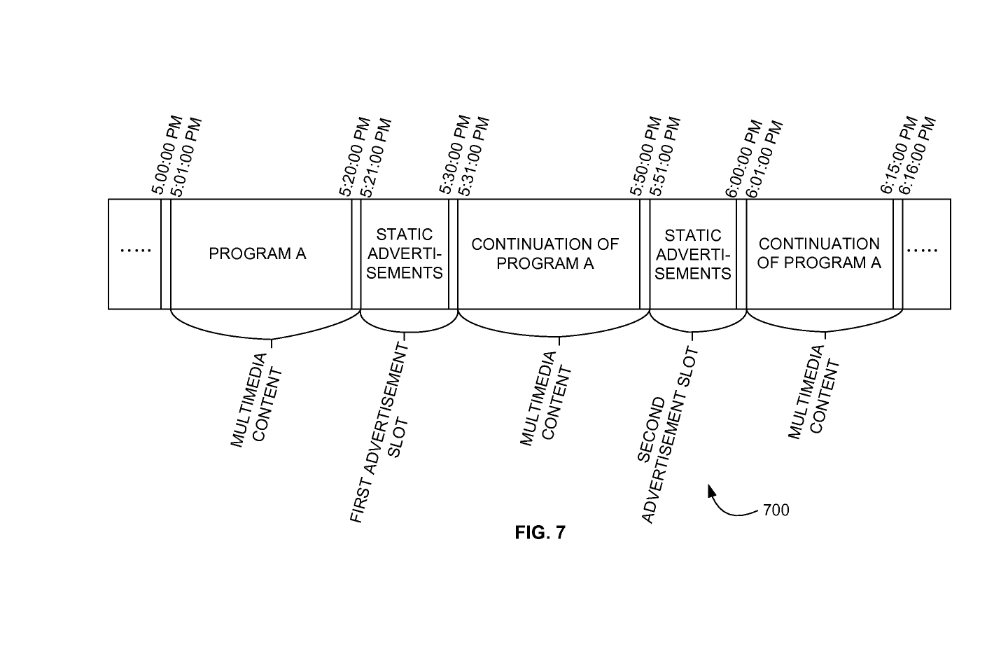

With reference to FIG. 6, FIG. 7 is a graphical representation 700 depicting a change in a schedule of a broadcast content that is obtained from the fixed point chart 500 due to clock drift according to one embodiment of the present disclosure. For example, due to a clock drift of 1 minute, there is a delay in a starting time of the program A, the pre-defined first advertisement slot, the second session, the pre-defined second advertisement slot, and the third session by 1 minute.

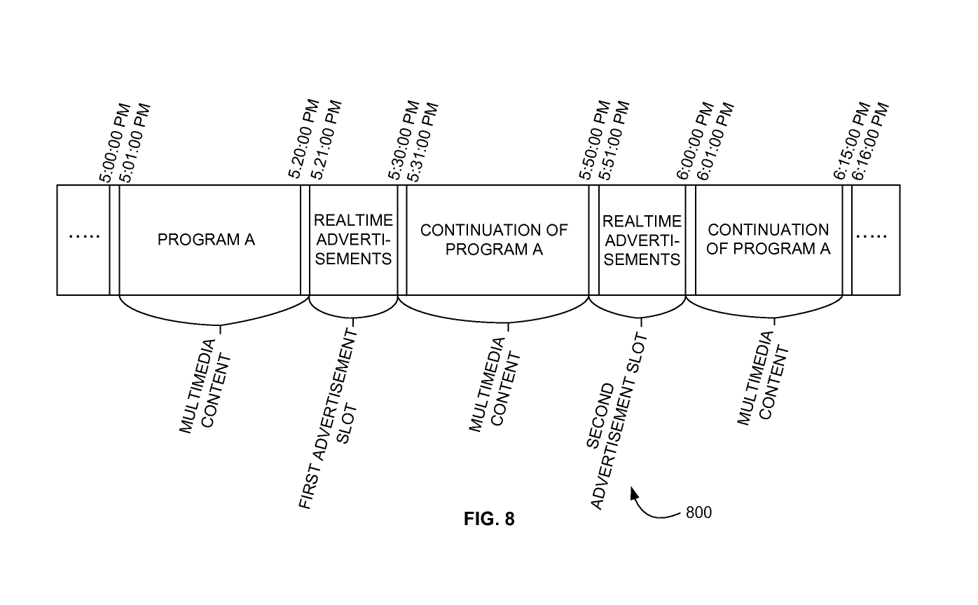

With reference to FIG. 6 and FIG. 7, FIG. 8 is a graphical representation 800 depicting a broadcast content including real-time advertisements that are stitched instead of static advertisements according to one embodiment of the present disclosure. For example, the cue-point engine 110 obtains a pre-defined start time (e.g., 5:20:01 PM) and a pre-defined end time (e.g., 5:30:00 PM) of the pre-defined first advertisement slot from a data source (e.g., a fixed point chart). Similarly, the cue-point engine 110 obtains a pre-defined start time (e.g., 5:50:01 PM) and a pre-defined end time (e.g., 6:00:00 PM) of the pre-defined second advertisement slot from a data source.

With the difference in audio signatures of the program A and audio signatures of static advertisements, the audio signature analyzing module 308 analyses audio signatures (e.g., a broadcast jingle) of data packets at the pre-defined start time (e.g., 5:50:01 PM) to identify a change in audio signatures. A change in the audio signatures indicates starting of the pre-defined first advertisement slot as scheduled. When a change in the audio signatures is not found, the audio signature analyzing module 308 analyses audio signatures of data packets that are nearby to the data packets at the pre-defined start time. The audio signature analyzing module 308 continues to analyze the audio signatures of data packets till a change in audio signatures is found. For instance, from the FIG. 7, the broadcast content with a clock drift of 1 minute, the audio signature analyzing module 308 identifies a change in audio signatures of data packets at 5:21:01 PM, and not at 5:20:01 PM. Thus, the clock drift identifying module 306 identifies a clock drift in the broadcast content. Similarly, a change in audio signatures of data packets at 5:31:00 PM indicates an end of the pre-defined first advertisement slot. Likewise, for all pre-defined advertisement slots, analysis of audio signatures of data packets is performed to identify actual start time and end time of the pre-defined advertisement slots. In one embodiment, the actual start time and end time identifying module 314 identifies the actual start time and the actual end time of each of the pre-defined advertisement slots further based on a SCTE35 tag that is embedded with the broadcast content before starting of each of pre-defined advertisement slots. Identification of a presence of a SCTE35 tag indicates a start of a pre-defined advertisement slot. Similarly, with a meta-tag at the start of each program that provides program details, or identifying a presence of silence or a black frame in the broadcast content before starting of each of the pre-defined advertisement slots indicates an actual start time and actual end of time of the advertisement slots. In one embodiment, the cue-point engine 110 identifies actual start time and actual end time of pre-defined advertisement slots based on channel logos. In one embodiment, the actual start time and the actual end time of the pre-defined advertisement slots are indicated manually.

In one embodiment, the encoding parameter analyzing module 310 analyses a change in encoding parameters of data packets that indicates actual start time and actual end time of pre-defined advertisement slots. For example, with reference to FIG. 6 and FIG. 7, a program identifier for a video of program A is 256, a program identifier for an audio of program A is 257, a program identifier for a video of static advertisements at pre-defined advertisement slots is 252, and a program identifier for an audio of static advertisements at the pre-defined advertisement slots is 253. The program identifier is widely used in prevalent MPEG Transport stream (TS) format. The encoding parameter analyzing module 310 identifies a change in a program identifier of data packets at 5:21:01 PM, and not at 5:20:01 PM. Thus, the clock drift identifying module 306 identifies a clock drift in the broadcast content. Similarly, a change in a program identifier of data packets at 5:31:00 PM indicates an end of the pre-defined first advertisement slot. Likewise, for all pre-defined advertisement slots, analysis of encoding signatures of data packets is performed to identify actual start time and end time of the pre-defined advertisement slots.

In another example, a change in encoding parameters (e.g., a change in resolution) indicates actual start time and actual end time of pre-defined advertisement slots.

For example, with reference to FIG. 6 and FIG. 7, a resolution of program A is 640 pixels×480 pixels, and a resolution of static advertisements at the pre-defined advertisement slots is 624 pixels×464 pixels. As described above, analysis of a resolution of data packets provides actual start time and actual end time of pre-defined advertisement slots. With the information on actual start time and actual end time of pre-defined advertisement slots, the streaming server 104 obtains one or more real-time advertisements from the local advertisement repository 114, and replaces the static advertisements occur in between actual start time and actual end time of pre-defined advertisement slots with the real-time advertisements. In one embodiment, a clock drift occurs in broadcasting specific data packets (e.g., the program A starts exactly at 5:00:00 PM, but data packets associated with the pre-defined first advertisement slot starts to broadcast at 5:20:20 PM with a delay of 20 seconds and ends at 5:30:00 PM on time). The clock drift identifying module 306 identifies the clock drift, and identifies actual start time as 5:20:20 PM, and accordingly the streaming server 104 stitches real-time advertisements between 5:20:20 PM and 5:30:00 PM.

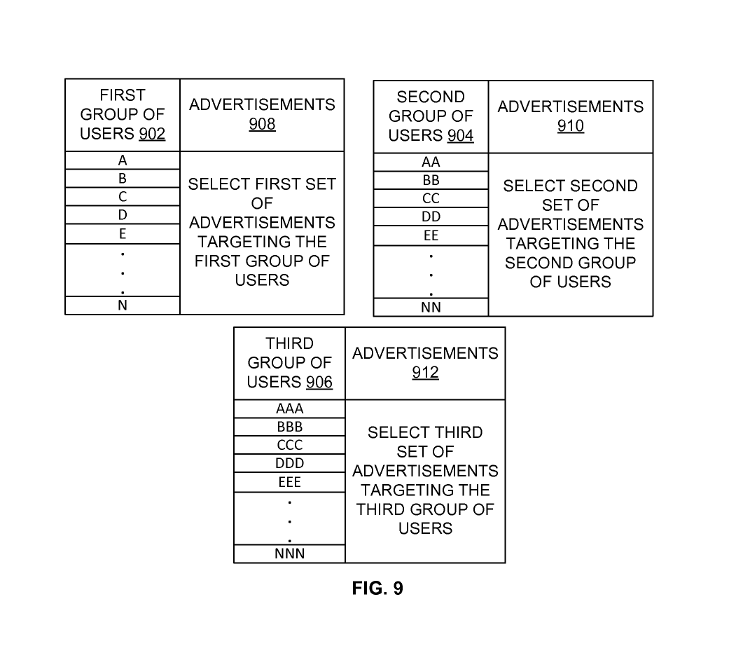

FIG. 9 is a table view illustrating groups of users requesting a broadcast content who are categorized based on target parameters set by an advertiser, and advertisements targeting each group of users according to one embodiment of the present disclosure. The streaming server 104 receives requests from a plurality of users for a broadcast content, and obtains user information including location information of the plurality of users. Based on targeting parameters set by an advertiser, the streaming server 104 categorizes the plurality of users requesting a broadcast content into one or more groups. Examples of targeting parameters include location information of users, age, gender, interests, purchase history, and other user related information. For instance, a first group of users 902 who request the broadcast content is from California, a second group of users 904 who request the broadcast content is from Arizona, and a third group of users 906 who request the broadcast content is from Colorado. The advertisement server 112 selects real-time advertisements from the local advertisement repository 114 based on targeting parameters set by an advertiser. For example, the advertisement server 112 selects a first set of advertisements 908 targeting the first group of users 902, a second set of advertisements 910 targeting the second group of users 904, and a third set of advertisements 912 targeting the third group of users 906. The streaming server 104 obtains the first set of advertisements 908 from the advertisement server 112, and replaces static advertisements that occur in between an actual start time and an actual end time of a pre-defined advertisement slot in the broadcast content with the first set of advertisements 908. The streaming server 112 then streams the broadcast content including a multimedia content and the first set of real-time advertisements 908 to user devices of the first group of users 902. Similarly, the streaming server 104 stitches the second set of advertisements 910 with a multimedia content, and streams the broadcast content including the multimedia content and the second set of advertisements 910 to user devices of the second group of users 904. Likewise, the streaming server 104 stitches the third set of advertisements 912 with a multimedia content, and streams the broadcast content including the multimedia content and the third set of advertisements 912 to user devices of the third group of users 906.

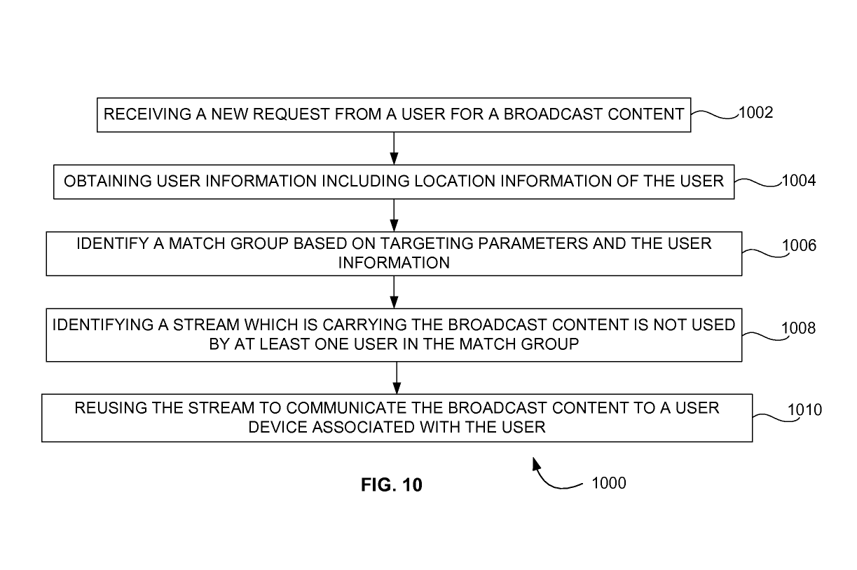

With reference to FIG. 9, FIG. 10 is a flow diagram 1000 illustrating a method for reusing a stream to deliver or communicate a broadcast content to a user device of a new user according to one embodiment of the present disclosure. In step 1002, a new request is received from a user for a broadcast content. For example, a user ‘ABC’ requests the streaming server 104 for the broadcast content which is already being watched by the first group of users 902, the second group of users 904, and the third group of users 906. In step 1004, user information including location information of the user is obtained. For instance, a location of the user ‘ABC’ is Colorado. In step 1006, a match group is identified based on targeting parameters and the user information. For instance, based on targeting parameters set by an advertiser and a user information (e.g., a location information of the user ‘ABC’ which is Colorado), the streaming server 104 identifies the match group as the third group of users 906 who are also from the same location. In step 1008, a stream is identified which is carrying the broadcast content is not used by one or more users in the match group. For instance, a stream that is carrying the broadcast content is not used by a user ‘CCC’ (e.g., may be the user ‘CCC’ is no longer watching a channel which airs the broadcast content). In step 1010, the stream is reused to communicate the broadcast content to a user device associated with the user. For instance, a stream that is carrying the broadcast content is not used by a user ‘CCC’, is reused to communicate the broadcast content to a user device associated with the user ‘ABC’. This avoids a need for multiple streams to communicate the broadcast content, and hence avoids the streaming server 104 becomes instable.

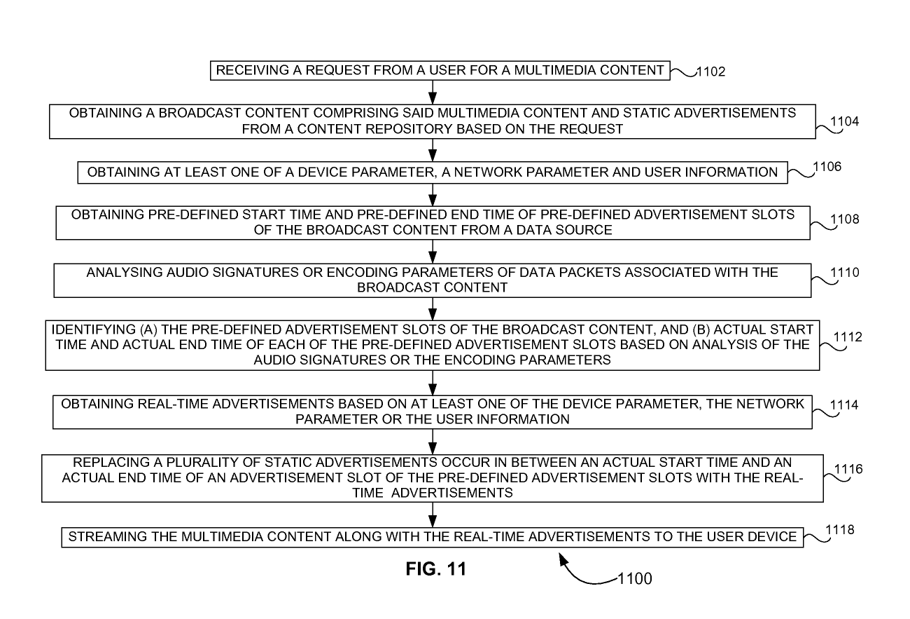

FIG. 11 is a flow diagram 1100 illustrating a method for streaming a multimedia content stitched with real-time advertisements to a user device of a user according to one embodiment of the present disclosure. In step 1102, a request is received from the user 102 for a multimedia content. In step 1104, a broadcast content including the multimedia content and static advertisements is obtained from the content repository 108 based on the request. The static advertisements are being stitched with the multimedia content at pre-defined advertisement slots. In step 1106, at least one of a device parameter that is related to the user device 106, a network parameter that is related to a network that interconnects the user device 106 and the streaming server 104, and/or user information is obtained. In step 1108, pre-defined start time and pre-defined end time of pre-defined advertisement slots of the broadcast content is obtained from a data source. In step 1110, audio signatures or encoding parameters of data packets associated with the broadcast content is analyzed. In step 1112, the pre-defined advertisement slots of the broadcast content, and (b) actual start time and actual end time of each of the pre-defined advertisement slots are identified based on analysis of the audio signatures and/or the encoding parameters.

In step 1114, real-time advertisements are obtained based on at least one of the device parameter, the network parameter, and/or the user information. In step 1116, a plurality of static advertisements occur in between an actual start time and an actual end time of an advertisement slot of the pre-defined advertisement slots is replaced with the real-time advertisements. The real-time advertisements start to stream at the actual start time. In step 1118, the multimedia content along with the real-time advertisements is streamed to the user device 106.

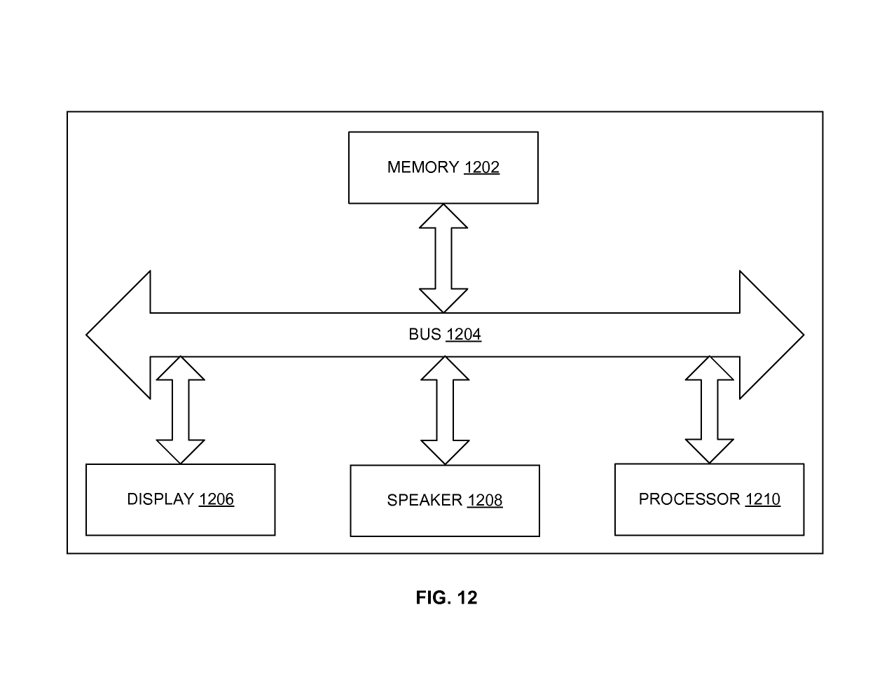

FIG. 12 illustrates an exploded view of a receiver of having an a memory 1202 having a set of computer instructions, a bus 1204, a display 1206, a speaker 1208, and a processor 1210 capable of processing a set of instructions to perform any one or more of the methodologies herein, according to an embodiment herein. The processor 1210 may also enable digital content to be consumed in the form of video for output via one or more displays 1206 or audio for output via speaker and/or earphones 1208. The processor 1210 may also carry out the methods described herein and in accordance with the embodiments herein.

Digital content may also be stored in the memory 1202 for future processing or consumption. The memory 1202 may also store program specific information and/or service information (PSI/SI), including information about digital content (e.g., the detected information bits) available in the future or stored from the past. A user of the receiver may view this stored information on display 1206 and select an item of for viewing, listening, or other uses via input, which may take the form of keypad, scroll, or other input device(s) or combinations thereof. When digital content is selected, the processor 1210 may pass information. The content and PSI/SI may be passed among functions within the receiver using the bus 1204.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly.

The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections).

In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can take the form of, an entirely hardware embodiment, an entirely software embodiment or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, remote controls, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

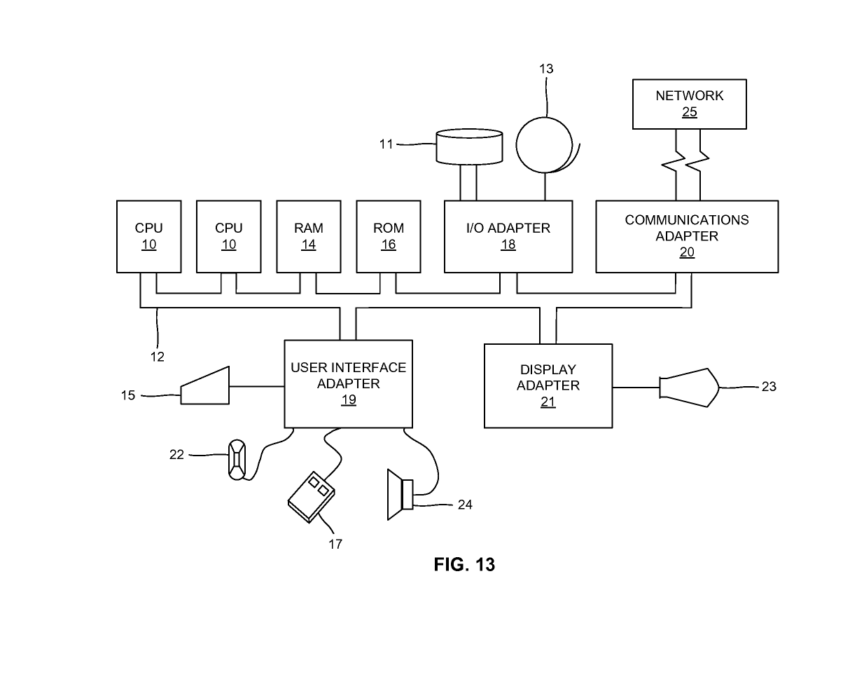

A representative hardware environment for practicing the embodiments herein is depicted in FIG. 13. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The content streaming system 100 that performs advertisement insertion which is an encoder agnostic, a CMS agnostic, and a device agnostic, and depends only on the video streaming protocol and a distribution mechanism. The content streaming system 100 freely integrates with any third party CMS and distribution platform, and hence it is flexible. The content streaming system 100 also interfaces with any third party advertisement network on standard protocols such as VAST/VPAID to serve advertisements which allow maximum fill rates, and which does not require any integration or dependency in encoders or an encoding mechanism, and works with streaming servers and CDNs. The content streaming system 100 further figures out the advertisement insertion necessities in a real-time, hence is dynamic in nature, and also an intelligent system hence easy to integrate. The content streaming system 100 uses stream timestamps and Meta packets to achieve frame accuracy for inserting mid-rolls ads, and use various optimization techniques to allow live advertisement insertions for millions of users. The content streaming system 100 stitches real-time advertisements at a right point in a broadcast content without creating disturbance in streaming program content. Further, advertisement blockers do not work with the current system 100 of FIG. 1. In case of streaming multimedia content, post-roll advertisements are streamed on exiting the current program being watched by a user. In one embodiment, when a user clicks on a channel stop button, the post-roll advertisements may start. After playback of the post-roll advertisements is finished, the channel is actually exited or closed.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

1. A content streaming system comprising:
(a) a streaming server comprising (i) a memory unit that comprises a database and a set of modules, and (ii) a processor that executes said set of modules, wherein said set of modules comprise:
(i) a request receiving module that receives a request from a user for a multimedia content, (ii) a broadcast content obtaining module that obtains a broadcast content comprising said multimedia content and static advertisements from a content repository based on said request, wherein said static advertisements (a) are being stitched with said multimedia program at pre-defined advertisement slots and (b) are common to a plurality of users who request said broadcast content, and (iii) a parameter obtaining module that obtains a device parameter that is related to a user device, a network parameter that is related to a network that interconnects said user device and said streaming server, and user information; and
(b) a cue-point engine communicatively coupled to said streaming server, wherein said cue-point engine comprises:
(i) a memory unit comprising (i) a set of modules and (ii) a database; and
(ii) a processor that executes said set of modules, wherein said set of modules comprise:
(a) a timestamp obtaining module, executed by said processor, that obtains pre-defined start time and pre-defined end time of said pre-defined advertisement slots of said broadcast content from a fixed point chart; and
(b) a clock drift identification module that:
(i) analyses audio signatures or encoding parameters of data packets associated with said broadcast content;
(ii) identifies (a) said pre-defined advertisement slots of said broadcast content, and (b) actual start time and actual end time of each of said pre-defined advertisement slots based on analysis of said audio signatures or said encoding parameters; and
(iii) identifies a mismatch between (a) a predefined start time of an advertisement slot of said predefined advertisements slots and an actual start time of said advertisement slot, or (b) a predefined end time of an advertisement slot of said predefined advertisements slots and an actual end time of said advertisement slot, and
wherein said streaming server is further configured to (a) receive real-time advertisements based on at least one of said device parameter, said network parameter or said user information, (b) replace a plurality of static advertisements occur in between said actual start time and said actual end time of said advertisement slot with said real-time advertisements upon identifying said mismatch, wherein said real-time advertisements start to stream at said actual start time, and (c) stream said multimedia content along with said real-time advertisements to said user device.

2. The content streaming system of claim 1, wherein said streaming server is further configured to:
(i) obtain user information comprising location information of a plurality of users requesting said broadcast content;
(ii) obtain a first set of advertisements targeting a first group of users of said plurality of users having at least one common targeting parameters;
(iii) replace static advertisements at said pre-defined advertisement slots of said broadcast content with said first set of advertisements, wherein said static advertisements at said pre-defined advertisement slots are mid-roll advertisements; and
(iv) communicate a first set of content streams comprising said broadcast content to user devices of said first group of users for streaming said broadcast content, wherein said broadcast content comprises said multimedia content that is stitched with said first set of advertisements.

3. The content streaming system of claim 2, wherein said streaming server is further configured to:
(v) obtain a second set of advertisements targeting a second group of users of said plurality of users having at least one common targeting parameters;
(vi) replace static advertisements at said pre-defined advertisement slots of said broadcast content with said second set of advertisements, wherein said static advertisements at said pre-defined advertisement slots are mid-roll advertisements; and
(vii) communicate a second set of content streams comprising said broadcast content to user devices of said second group of users, wherein said broadcast content comprises said multimedia content that is stitched with said second set of advertisements.

4. The content streaming system of claim 3, wherein said streaming server is further configured to:
(i) receive a new request from another user for said broadcast content;
(ii) obtain user information comprising a location information of said user;
(iii) identify a match group based on targeting parameters and said user information, wherein said match group is said first group of users or said second group of users having at least one common targeting parameters with respect to said user information; and
(iv) re-use a stream from said first set of streams or said second set of streams based on said match group to communicate said broadcast content to a user device associated with said user.

5. The content streaming system of claim 4, wherein said first group of users and second group of users are dynamically updated based on a new campaign, a change in said targeting parameters associated with said first group or said second group, or an expiry of existing campaign.

6. The content streaming system of claim 1, further comprising an advertisement server that is communicatively coupled to said streaming sever and said cue-point engine is configured to (a) select said real-time advertisements dynamically based on at least one of said device parameter, said network parameter or said user information, (ii) provide an interface for content publishers to ingest broadcast content and properties of said broadcast content, and (iii) provide an interface for advertisers to provide campaign data.

7. The content streaming system of claim 6, further comprising an advertisement stitching engine, wherein said advertisement stitching engine comprises:
(a) a content format parsing module that (i) parses data packets of said multimedia content to extract said encoding parameters, (ii) interacts with said cue-point engine to obtain said pre-defined advertisement slots that is identified based on said audio signatures or said encoding parameters, and (iii) interacts with said advertisement server to obtain said real-time advertisements dynamically;
(b) an advertisement format processing module that repurposes said real-time advertisements to match with said encoding parameters of said multimedia content; and
(c) an advertisement inserting module that inserts said real-time advertisements in between said multimedia content for streaming at said user device.

8. The content streaming system of claim 1, wherein said encoding parameters is selected from the group comprising of: resolution, frame rate, reference frames, codec and profile, initial quantization parameters, deblocking filter coefficients, sequence parameter set, picture parameter set, audio codec and profile, sampling rate, and number of channels.

9. The content streaming system of claim 1, wherein said real-time advertisements are at least one of a pre-roll advertisement and a mid-roll advertisement.

10. The content streaming system of claim 1, wherein said clock drift identification module identifies said actual start time and said actual end time of each of said pre-defined advertisement slots further based on SCTE35 tags that are embedded with said broadcast content.

11. The content streaming server of claim 1, wherein said clock drift identification module further (a) identifies a presence of silence in said broadcast content before starting of each of said pre-defined advertisement slot, and (b) identifies an actual start time of each of said pre-defined advertisement slots based on said presence of silence that is identified.

12. The content streaming of claim 1, wherein said clock drift identification module further identifies said actual start time of each of said pre-defined advertisement slots based on a presence of a black frame in said broadcast content before starting of each of said pre-defined advertisement slots.

13. The content streaming system of claim 1, wherein said streaming server (a) streams at least one pre-roll advertisement before streaming said multimedia content that is requested by a plurality of users, and (b) streams said multimedia content or said real-time advertisements based on available data packets after completing streaming of said pre-roll advertisement.

14. The content streaming system of claim 7, wherein said advertisement server or said advertisement stitching engine further comprises a timestamp modifying module that modifies timestamp associated with packets of said real-time advertisements by adding said timestamp of packets of said real-time advertisements with a timestamp at a start packet of said multimedia content.

15. A method for inserting real-time advertisements in a broadcast content and streaming said broadcast content comprising:
(a) receiving a request from a user for a multimedia content;
(b) obtaining a broadcast content comprising said multimedia content and static advertisements from a content repository based on said request, wherein said static advertisements are being stitched with said multimedia content at pre-defined advertisement slots;
(c) obtaining at least one of a device parameter that is related to a user device, a network parameter that is related to a network that interconnects said user device and a streaming server, and user information;
(d) obtaining pre-defined start time and pre-defined end time of pre-defined advertisement slots of said broadcast content from a data source;
(e) analyzing audio signatures or encoding parameters of data packets associated with said broadcast content;
(f) identifying (a) said pre-defined advertisement slots of said broadcast content, and (b) actual start time and actual end time of each of said pre-defined advertisement slots based on analysis of said audio signatures or said encoding parameters;
(g) obtaining real-time advertisements based on at least one of said device parameter, said network parameter or said user information;
(h) replacing a plurality of static advertisements occur in between an actual start time and an actual end time of an advertisement slot of said pre-defined advertisement slots with said real-time advertisements, wherein said real-time advertisements start to stream at said actual start time; and
(i) streaming said multimedia content along with said real-time advertisements to said user device.

16. The method of claim 15, further comprising:
(i) obtaining user information comprising location information of a plurality of users requesting said broadcast content;
(ii) obtaining a first set of advertisements targeting a first group of users of said plurality of users having at least one common targeting parameters;
(iii) replacing static advertisements at said pre-defined advertisement slots of said broadcast content with said first set of advertisements, wherein said static advertisements at said pre-defined advertisement slots are mid-roll advertisements; and
(iv) communicating a first set of content streams comprising said broadcast content to user devices of said first group of users for streaming said broadcast content, wherein said broadcast content comprises said multimedia content that is stitched with said first set of advertisements.

17. The method of claim 14, further comprising:
(v) obtaining a second set of advertisements targeting a second group of users of said plurality of users having at least one common targeting parameters;
(vi) replacing static advertisements at said pre-defined advertisement slots of said broadcast content with said second set of advertisements, wherein said static advertisements at said pre-defined advertisement slots are mid-roll advertisements; and
(vii) communicating a second set of content streams comprising said broadcast content to user devices of said second group of users, wherein said broadcast comprises said multimedia content that is stitched with said second set of advertisements.

18. The method of claim 17, further comprising:
(i) receiving a new request from another user for said broadcast content;
(ii) obtaining user information comprising a location information of said user;
(iii) identifying a match group based on targeting parameters and said user information, wherein said match group is said first group of users or said second group of users having at least one common targeting parameters with respect to said user information; and
(iv) re-using a stream from said first set of streams or said second set of streams based on said match group to communicate said broadcast content to a user device associated with said user.

19. A cue-point engine comprising:
(i) a memory unit comprising (a) a set of modules and (b) a database, and
(ii) a processor that executes said set of modules, wherein said set of modules comprise:
(a) a timestamp obtaining module, executed by said processor, that obtains pre-defined start time and pre-defined end time of pre-defined advertisement slots of a broadcast content from a data source, wherein said broadcast content comprises said multimedia content and static advertisements is obtained from a content repository; and
(b) a clock drift identification module that:
(i) analyses audio signatures or encoding parameters of data packets associated with said broadcast content;
(ii) identifies (a) said pre-defined advertisement slots of said broadcast content, and (b) actual start time and actual end time of each of said pre-defined advertisement slots based on analysis of said audio signatures or said encoding parameters; and
(iii) identifies a mismatch between (a) a predefined start time of an advertisement slot of said predefined advertisements slots and an actual start time of said advertisement slot, or (b) a predefined end time of an advertisement slot of said predefined advertisements slots and an actual end time of said advertisement slot, wherein a plurality of static advertisements occur in between said actual start time and said actual end time of said advertisement slot is replaced with real-time advertisements upon identifying said mismatch, wherein said multimedia content along with said real-time advertisements is streamed to a user device.

20. The cue-point engine of claim 16, wherein said real-time advertisements are mid-roll advertisements.
